(19) United States
(12) Patent Application Publication
(10) Pub. No.: US 2025/0273847 A1
(43) Pub. Date: Aug. 28, 2025

(54) WIRELESS COMMUNICATION APPARATUS AND WIRELESS COMMUNICATION METHOD

(71) Applicant: SONY GROUP CORPORATION, TOKYO (JP)

(72) Inventors: KAZUKI ATSUTA, TOKYO (JP); TADASHI SASAKI, TOKYO (JP)

(21) Appl. No.: 18/859,684

(22) PCT Filed: May 1, 2023
(86) PCT No.: PCT/JP2023/017015

§ 371 Date: Oct. 24, 2024

(30) Foreign Application Priority Data
May 2, 2022 (JP) 2022-076256

(51) Int. Cl. H01Q 1/24; H01Q 21/28

(52) U.S. Cl. CPC H01Q 1/24; H01Q 21/28

(57) ABSTRACT

There is provided a wireless communication apparatus including multiple antennas, multiple reception sections each connected to a corresponding one of the multiple antennas and configured to receive a radio signal through the corresponding one of the multiple antennas, and an adjustment section configured to generate a received signal by performing a reception process in reference to the radio signal received in plural number by the multiple reception sections, in which a first antenna and a second antenna included in the multiple antennas are a predetermined length apart in a vertical direction.

### CROSS REFERENCE TO RELATED APPLICATIONS

This application claims the benefit of Japanese Priority Patent Application JP 2022-076256 filed May 2, 2022, the entire contents of which are incorporated herein by reference.

### TECHNICAL FIELD

The present disclosure relates to a wireless communication apparatus and a wireless communication method.

### BACKGROUND ART

During flight of an unmanned aircraft (i.e., drone), wireless communication takes place between the drone and its controller. That is, the drone and the controller may each be considered a wireless communication apparatus. For example, the controller transmits to the drone radio signals including a control signal for controlling the flight of the drone. In turn, the drone transmits to the controller radio signals including videos taken by a camera mounted to the drone.

Upon receipt of radio signals transmitted from the drone, the controller receives not only direct waves from the drone but also reflected waves from the ground. As a result, an interference between the direct waves and the reflected waves causes a propagation loss. Such propagation losses are known to be degraded not uniformly in proportion to the communication distance between the drone and the controller but cyclically at points where the propagation loss is aggravated.

PTL 1 describes a technology that involves setting up two antennas of different heights on the transmitting side to implement time-division transmission diversity and thereby improve the transmission loss attributable to the interference between direct waves and reflected waves. However, applying this technology to drones may require drastically remodeling them.

### CITATION LIST

### Patent Literature

### [PTL 1]

Japanese Patent Laid-open No. 2000-22425

### SUMMARY

### Technical Problem

The present disclosure has been designed to solve the above and other problems. It is desirable to provide a wireless communication apparatus that easily improves the propagation loss caused by an interference between direct waves and reflected waves of radio signals being received.

### Solution to Problem

According to an embodiment of the present disclosure, there is provided a wireless communication apparatus including multiple antennas, multiple reception sections each connected to a corresponding one of the multiple antennas and configured to receive a radio signal through the corresponding one of the multiple antennas, and an adjustment section configured to generate a received signal by performing a reception process in reference to multiple radio signals received by the multiple reception sections. A first antenna and a second antenna included in the multiple antennas are a predetermined length apart in a vertical direction.

According to an embodiment of the present disclosure, there is also provided a wireless communication method including the steps of arranging multiple antennas in such a manner that a first antenna and a second antenna included in the multiple antennas are a predetermined length apart in a vertical direction, receiving a radio signal through the multiple antennas, and generating a received signal by performing a reception process in reference to multiple radio signals.

### BRIEF DESCRIPTION OF DRAWINGS

FIG. 1 is a diagram depicting a configuration of an unmanned aircraft system related to a first embodiment.

FIG. 2 is a block diagram depicting a functional configuration of a drone related to the first embodiment.

FIG. 3 is a block diagram depicting a functional configuration of a controller related to the first embodiment.

FIG. 4 is a diagram schematically depicting a structure of a housing of the controller related to the first embodiment.

FIG. 5 is a diagram depicting an example of a dipole antenna.

FIG. 6 is a diagram depicting an example of a microstrip antenna.

FIG. 7 is a schematic diagram explaining a state in which radio signals transmitted from an antenna of the drone are received by a first antenna and a second antenna of the controller.

FIG. 8A depicts results of simulations regarding the relation between propagation loss and communication distance in a case where L=0 mm and f=2.45 GHZ.

FIG. 8B depicts results of simulations regarding the relation between propagation loss and communication distance in a case where L=0 mm and f=5.8 GHZ.

FIG. 9A depicts results of simulations regarding the relation between propagation loss and communication distance in a case where L=10 mm and f=2.45 GHZ.

FIG. 9B depicts results of simulations regarding the relation between propagation loss and communication distance in a case where L=10 mm and f=5.8 GHZ.

FIG. 10A depicts results of simulations regarding the relation between propagation loss and communication distance in a case where L=100 mm and f=2.45 GHZ.

FIG. 10 depicts results of simulations regarding the relation between propagation loss and communication distance in a case where L=100 mm and f=5.8 GHZ.

FIG. 11 is a diagram schematically depicting a structure of a housing of a controller related to a second embodiment.

FIG. 12 is a diagram schematically depicting a structure of a housing of another controller related to the first embodiment.

### DESCRIPTION OF EMBODIMENTS

Some embodiments of the present disclosure are described below with reference to the accompanying drawings. In the description that follows, the controller of an unmanned aircraft (drone) is explained as an example of a wireless communication apparatus embodying the present disclosure. It is to be noted, however, that the scope of the technology related to the present disclosure is not limited to the controller for drones. Throughout the drawings, like or corresponding elements are designated by like reference signs, and their detailed descriptions are omitted where they are redundant.

### First Embodiment

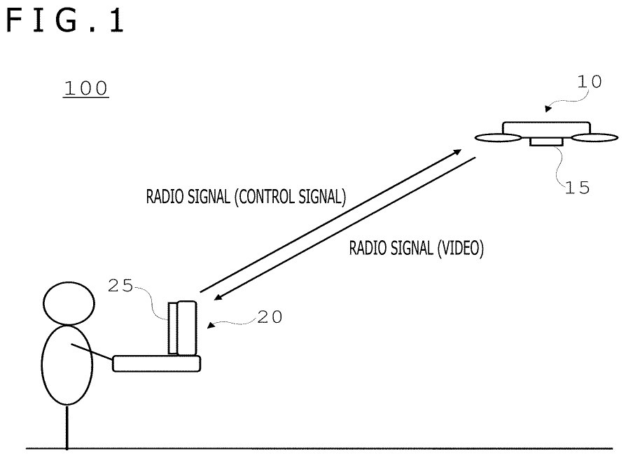

FIG. 1 is a diagram depicting a configuration of an unmanned aircraft system 100 related to a first embodiment of the present disclosure. The unmanned aircraft system 100 includes a drone 10 and a controller 20. The drone 10 flies according to a control signal included in the radio signals transmitted from the controller 20. The controller 20 is operated by a user and transmits the radio signals including the control signal for controlling the flight of the drone 10. The drone 10, in turn, transmits to the controller 20 radio signals including videos taken by a camera 15 mounted to the drone 10. The controller 20 extracts the videos from the radio signals transmitted from the drone 10 and causes a display section 25 to display the extracted videos.

### (Configuration of the Drone)

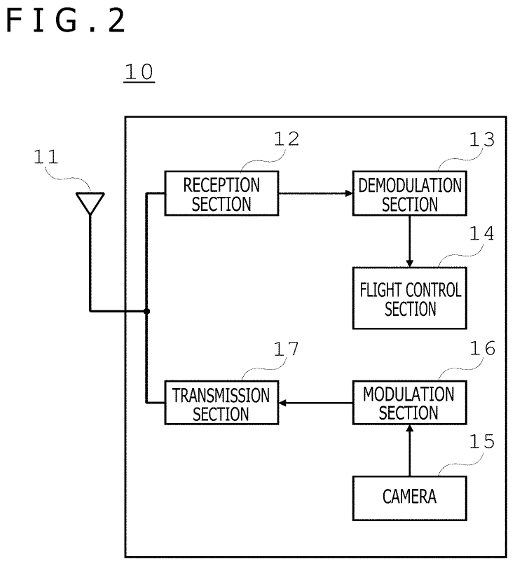

FIG. 2 is a block diagram depicting a functional configuration of the drone 10. The drone 10 includes an antenna 11, a reception section 12, a demodulation section 13, a flight control section 14, a camera 15, a modulation section 16, and a transmission section 17.

The reception section 12 receives via the antenna 11 the radio signals transmitted from the controller 20. The demodulation section 13 demodulates the radio signals received by the reception section 12 and extracts therefrom the control signal for controlling the flight of the drone 10. The flight control section 14 controls the flight of the drone 10 by controlling rotors and tail units thereof, which are not depicted, according to the control signal output from the demodulation section 13.

The camera 15 is attached to the bottom of the airframe of the drone 10 and takes videos of what is below the drone 10. The modulation section 16 modulates a video signal output from the camera 15 and outputs the modulated signal as radio signals. The transmission section 17 transmits, to the controller 20 by way of the antenna 11, the radio signals output from the modulation section 16.

### (Configuration of the Controller)

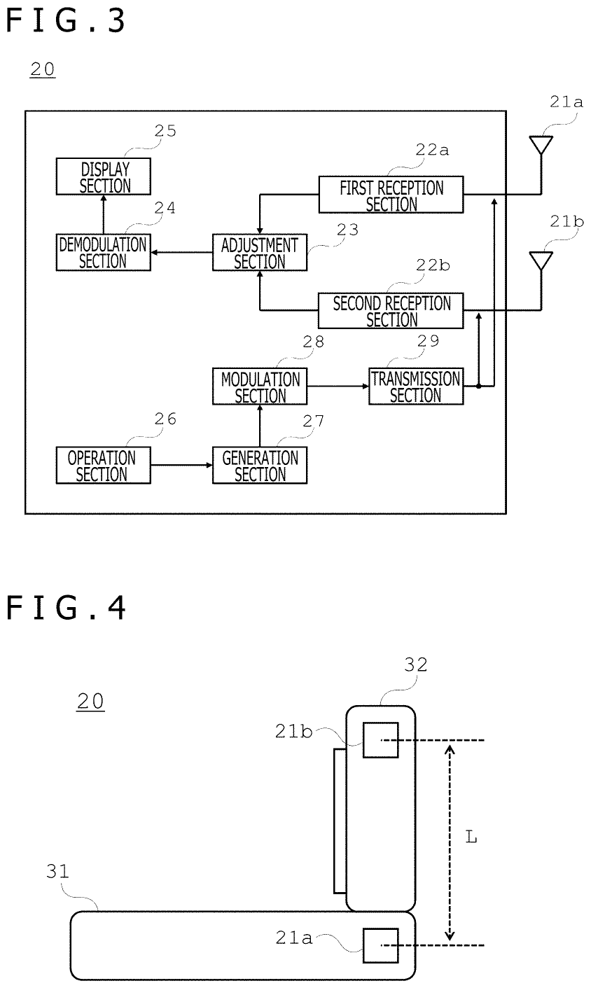

FIG. 3 is a block diagram depicting a functional configuration of the controller 20. The controller 20 includes a first antenna 21a, a second antenna 21b, a first reception section 22a, a second reception section 22b, an adjustment section 23, a demodulation section 24, a display section 25, an operation section 26, a generation section 27, a modulation section 28, and a transmission section 29.

The first antenna 21a and the second antenna 21b are, for example, a dipole antenna, a microstrip antenna (patch antenna), or a sector antenna each. The first antenna 21a and the second antenna 21b should preferably be of the same type and of the same shape but may be of different types and of different shapes. Further, as will be discussed later, the first antenna 21a and the second antenna 21b are placed a predetermined length apart in a vertical direction.

The first reception section 22a receives via the first antenna 21a the radio signal transmitted from the drone 10. The second reception section 22b receives via the second antenna 21b the radio signal also transmitted from the drone 10.

From a first radio signal received by the first reception section 22a and from a second radio signal received by the second reception section 22b, the adjustment section 23 generates and outputs a received signal of which the propagation loss is improved. More specifically, the adjustment section 23 performs either selective diversity or maximum ratio combining (MRC) diversity. In the case of performing selective diversity, the adjustment section 23 selects either the first radio signal or the second radio signal, whichever has the greater signal intensity, and outputs the selected signal as the received signal. In the case of carrying out MRC diversity, the adjustment section 23 adjusts the amplitudes and phases of the first radio signal and the second radio signal before combining them in such a manner as to obtain a maximum SNR, and outputs the combined signals as the received signal.

The demodulation section 24 demodulates the received signal output from the adjustment section 23, to extract a video signal. The display section 25 includes a liquid crystal display unit, for example, and causes the display unit to display the video output from the demodulation section 24.

The operation section 26 includes buttons and levers, for example. The operation section 26 functions as means through which the flight motion of the drone 10 is input to the controller 20 as intended by the user. In reference to the information input through the operation section 26, the generation section 27 generates a control signal for controlling the flight of the drone 10.

The modulation section 28 modulates the control signal output from the generation section 27, and outputs the modulated signal as a radio signal. The transmission section 29 transmits the radio signal output from the modulation section 28, to the drone 10 by way of the first antenna 21a and the second antenna 21b.

### (Structure of the Housing of the Controller)

FIG. 4 is a diagram schematically depicting a structure of a housing of the controller 20. In the description that follows, it is assumed that gravity works downward as viewed in the drawing and that the direction parallel to gravity is defined as the “vertical direction.” The housing of the controller 20 includes a main body 31 gripped by the user and an extension part 32 extending vertically upward from the main body 31. The first antenna 21a is fixedly placed inside the main body 31. The second antenna 21b is fixedly placed inside the extension part 32.

The first antenna 21a has a position determined as its reference (i.e., reference position). Likewise, the second antenna 21b has a position determined as its reference (reference position). For example, the reference position on each of the first antenna 21a and the second antenna 21b may be a feeding point, a tip end part, a base end part, or an attaching part of the first antenna 21a and the second antenna 21b. However, this is not how the reference position may be determined. Any desired position of any antenna may be determined as the reference position.

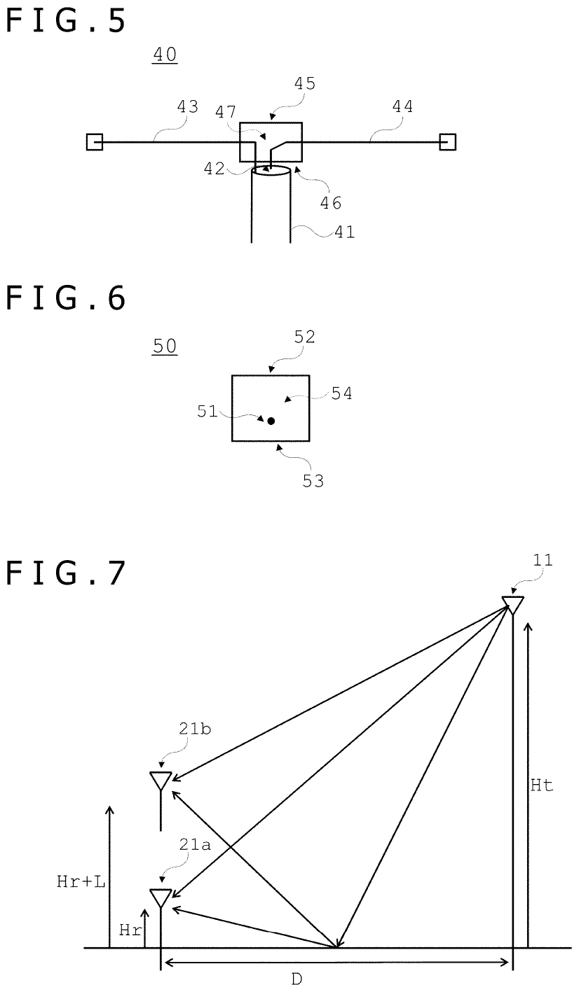

For example, on a dipole antenna 40 such as the one depicted in FIG. 5, a feeding point 42 is located at the tip end of a cable 41. From the feeding point 42, two linear lead wires 43 and 44 extend symmetrically to the right and to the left. In this case, the feeding point 42 at the tip end of the cable 41 may be determined as the reference position, for example. Alternatively, a tip end part 45 of the antenna may be determined as the reference position. As another alternative, a base end part 46 of the antenna may be determined as the reference position. As yet another alternative, an attaching part 47 of the antenna may be determined as the reference position. These parts, however, are not limitative of how the reference position of the dipole antenna may be determined. Any other position of the dipole antenna may be determined as the reference position.

In another example, in the case of a flat plate-like microstrip antenna (patch antenna) 50 such as the one depicted in FIG. 6, a feeding point 51 of the antenna 50 may be determined as the reference position. Alternatively, a tip end part 52 of the antenna 50 may be determined as the reference position. As another alternative, a base end part 53 of the antenna 50 may be determined as the reference position. As yet another alternative, an attaching part 54 of the antenna 50 may be determined as the reference position. These parts, however, are not limitative of how the reference position of the microstrip antenna may be determined. Any other position of the microstrip antenna may be determined as the reference position.

Described with reference to FIG. 4 again, in the first embodiment, the first antenna 21a and the second antenna 21b are each a flat plate-like microstrip antenna. The feeding point of each of these antennas is determined as the reference position. Further, the reference position of the first antenna 21a and that of the second antenna 21b are arranged a predetermined length L apart in the vertical direction. Here, the predetermined length L is set to be at least ½ times the wavelength of the radio signals received by the first antenna 21a and the second antenna 21b. More specifically, the length L is set to be from 0.5 to 0.9 times the wavelength of the radio signals. The predetermined length L set in such a manner makes it possible to improve the propagation loss caused by an interference between the direct wave and the indirect wave of the radio signals being received, as discussed below in detail.

### (Improvement of the Propagation Loss Owing to the Arrangement of the First Antenna and the Second Antenna)

Explained next is the reason why the first antenna 21a and the second antenna 21b of the controller 20 arranged the predetermined length L apart in the vertical direction as described above improve the propagation loss attributable to the interference between the direct wave of the radio signals and the reflected wave thereof from the ground during signal transmission from the drone 10 to the controller 20.

FIG. 7 is a schematic diagram explaining a state in which the radio signals transmitted from the antenna 11 of the drone 10 are received by the first antenna 21a and the second antenna 21b of the controller 20. In FIG. 7, a reference sign Ht stands for the height of the antenna 11 from the ground, Hr for the height of the first antenna 21a from the ground, Hr+L for the height of the second antenna 21b from the ground, D for a horizontal distance between the antenna 11 on one hand and the first antenna 21a and the second antenna 21b on the other hand, i.e., the communication distance therebetween, and A for the wavelength of the radio signals.

The first antenna 21a receives the direct wave of the radio signals transmitted from the antenna 11 and the reflected wave of the transmitted radio signals from the ground. At this time, the propagation loss as the ratio between the transmitting power Pt of the antenna 11 and the receiving power Pr1 of the first antenna 21a may be calculated by use of the mathematical formula (1) below. In the formula (1), Gt stands for the gain of the antenna 11 and Gr for the gain of the first antenna 21a and the second antenna 21b.

$$\begin{matrix}[ Math . 1 ] & \\ \frac{{P}_{r 1}}{{P}_{t}} = {( \frac{λ}{2 π D} sin ( \frac{{ϕ}_{1}}{2} ) )}^{2} {G}_{r} {G}_{t} & ( 1 )\end{matrix}$$

$${ϕ}_{1} \approx \frac{4 π {H}_{r} {H}_{t}}{λ D}$$

The second antenna 21b receives the direct wave of the radio signals transmitted from the antenna 11 and the reflected wave of the transmitted radio signals from the ground. At this time, the propagation loss as the ratio between the transmitting power Pt of the antenna 11 and the receiving power Pr2 of the second antenna 21b may be calculated by use of the mathematical formula (2) below.

$$\begin{matrix}[ Math . 2 ] & \\ \frac{{P}_{r 2}}{{P}_{t}} = {( \frac{λ}{2 π D} sin ( \frac{{ϕ}_{2}}{2} ) )}^{2} {G}_{r} {G}_{t} & ( 2 )\end{matrix}$$

$${ϕ}_{2} \approx \frac{4 π ( {H}_{r} + L ) {H}_{t}}{λ D}$$

In the above mathematical formulas (1) and (2), the point at which the propagation loss gets worse appears repeatedly in a cycle of π due to the nature of the sine function. For this reason, in the case where a phase φ1/2 in the sine function of the formula (1) does not coincide with a phase φ2/2 in the sine function of the formula (2) and where the propagation loss on one signal side gets worse, the propagation loss on the other signal side gets better by contrast. Thus, the propagation loss is improved by implementing either selective diversity or MRC diversity.

When, specifically, the distance in the vertical direction between the first antenna 21a and the second antenna 21b, i.e., the predetermined length L, is at least ½ times the wavelength λ of the radio signals or when, more particularly, the predetermined length L is 0.5 to 0.9 times the wavelength λ of the radio signals, the phase difference between the formulas (1) and (2) above is in an appreciably preferable state. This permits improvement of the propagation loss caused by the interference between the direct wave of the radio signals and the reflected wave thereof from the ground.

### (Results of Simulations)

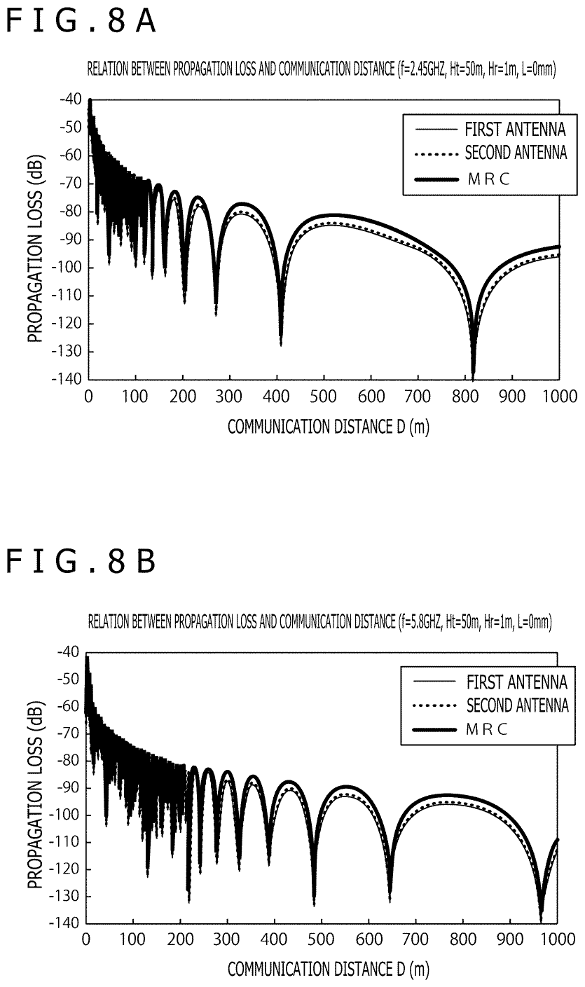

FIGS. 8A and 8B depict results of simulations regarding the relation between propagation loss and communication distance in the case where L=0 mm. For purpose of calculation, the frequency of the radio signals is set to be f=2.45 GHz in FIG. 8A and f=5.8 GHz in FIG. 8B. Further, the height of the antenna 11 of the drone 10 from the ground is set to be Ht=50 m; the height of the first antenna 21a of the controller 20 from the ground is set to be Hr=1 m; the distance in the vertical direction between the first antenna 21a and the second antenna 21b is set to be L=0 mm; and the communication distance is set to be D=0 to 1000 m for purpose of calculation.

In the drawings, solid lines denote the propagation loss calculated from a first received signal received by the first antenna 21a, and broken lines represent the propagation loss calculated from a second received signal received by the second antenna 21b. Further, thick lines stand for the propagation loss of a received signal generated from the first received signal and the second received signal through MRC diversity. In the case where L=0 mm, the first received radio and the second received radio are in phase with each other according to the formulas (1) and (2) above. Hence, the points of communication distance where the propagation loss gets worse appear at approximately 400 m and 800 in FIG. 8A, for example, the points coinciding with each other between the two signals. Consequently, implementing MRC diversity still fails to improve the propagation loss significantly, the improvement being merely approximately 3 dB.

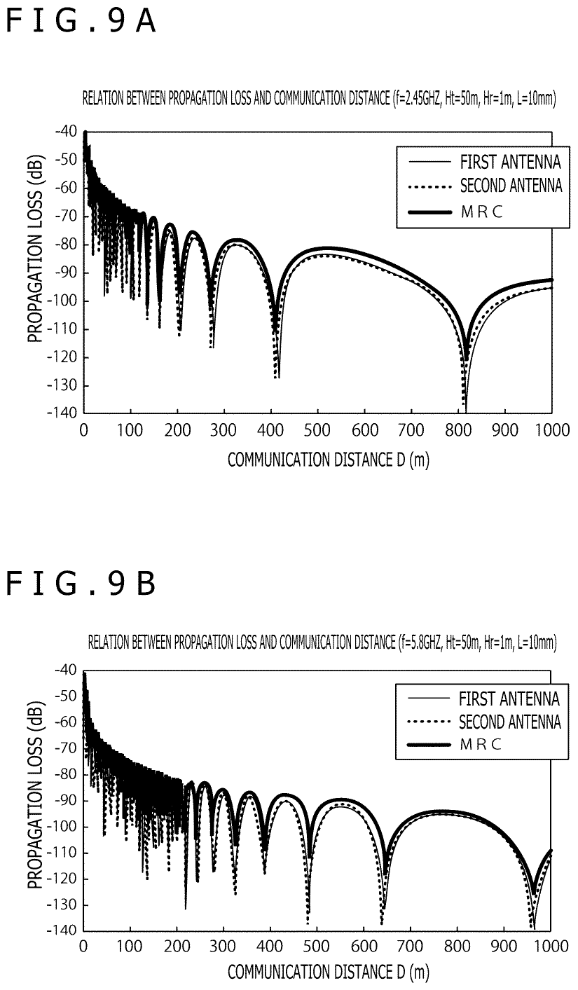

FIGS. 9A and 9B depict results of simulations regarding the relation between propagation loss and communication distance in the case where L=10 mm. For purpose of calculation, the frequency of the radio signals is set to be f=2.45 GHz in FIG. 9A and f=5.8 GHz in FIG. 9B. In the case where L=10 mm, the first received signal and the second received signal are slightly out of phase with each other according to the formulas (1) and (2) above. Hence, the points of communication distance where the propagation loss gets worse appear in a manner slightly in disagreement between the two signals. Where the propagation loss gets worse at a given point on one signal side, the propagation loss at that point gets better by comparison on the other signal side. This makes it possible to improve the propagation loss through implementation of MRC diversity. In particular, a loss improvement of approximately 20 dB can be observed at the point where the improvement is most prominent.

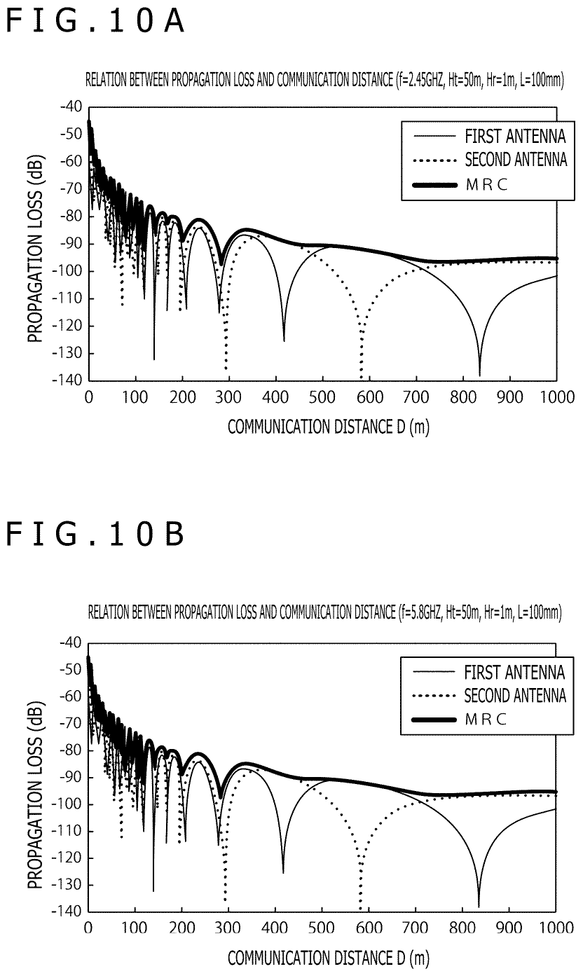

FIGS. 10A and 10B depict results of simulations regarding the relation between propagation loss and communication distance in the case where L=100 mm. For purpose of calculation, the frequency of the radio signals is set to be f=2.45 GHz in FIG. 10A and f=5.8 GHz in FIG. 10B. In the case where L=100 mm, the first received signal and the second received signal are significantly out of phase with each other according to the formulas (1) and (2) above. Hence, the points of communication distance where the propagation loss gets worse appear in a manner prominently in disagreement between the two signals. Where the propagation loss gets worse at a given point on one signal side, the propagation loss at that point gets better by contrast on the other signal side. Accordingly, implementing MRC diversity allows both sides to complement each other, thereby appreciably improving the propagation loss. In particular, a loss improvement of approximately 30 dB or better can be observed at the point where the improvement is most prominent.

As explained above, the controller 20 related to the first embodiment includes the first antenna 21a and the second antenna 21b. From the first radio signal received via the first antenna 21a and from the second radio signal received via the second antenna 21b, the controller 20 generates a received signal of which the propagation loss is improved. Further, the first antenna 21a and the second antenna 21b are the predetermined length L apart in the vertical direction. Such characteristics allow the controller 20 of the first embodiment to easily improve the propagation loss caused by the interference between the direct wave and the reflected wave of the radio signals being received. In particular, in a case where the technology of the first embodiment is applied to existing unmanned aircraft systems, there is absolutely no need to remodel the drone on the transmitting side. Mere modification of controller on the receiving side is sufficient.

As discussed above, the predetermined length L should preferably be set to be approximately 0.5 to 0.9 times the wavelength λ of the radio signals. Setting the predetermined length L in such a manner notably improves the propagation loss of the radio signals. For example, when the frequency of the radio signals is f=2.4 GHz, the length L should preferably be set to fall within the range of L=60 mm to L=113 mm. In another example, when the frequency of the radio signals is f=5 GHz, the length L should preferably be set to fall within the range of L=25 mm to L=54 mm.

The processes of generating the received signal of which the propagation loss is improved given the first radio signal and the second radio signal may be carried out through selective diversity or MRC diversity, for example. By taking advantage of the fact that, where the propagation loss gets worse at a given point on one signal side, the propagation loss at that point gets better by contrast on the other signal side, these processes permit both sides to complement each other and thereby improve the propagation loss appreciably.

Whereas the first embodiment has been explained above using the example in which the controller 20 includes two antennas, the technology of the first embodiment may also be applied to cases where three or more antennas are provided. For example, in a case where there are three antennas, a first antenna may be arranged at a height Gr from the ground, a second antenna at a height Hr+L from the ground, and a third antenna at a height Hr-L from the ground. In addition, in a case where there are four antennas, a pair of antennas may be arranged in parallel with each other at the same height Hr from the ground, and another pair of antennas in parallel with each other at the same height Hr+L from the ground.

Alternatively, the drone 10 and the controller 20 may swap their roles, with two or more antennas attached to the drone 10. In this case, the propagation loss of the radio signals transmitted from the controller to the drone can be improved.

### Second Embodiment

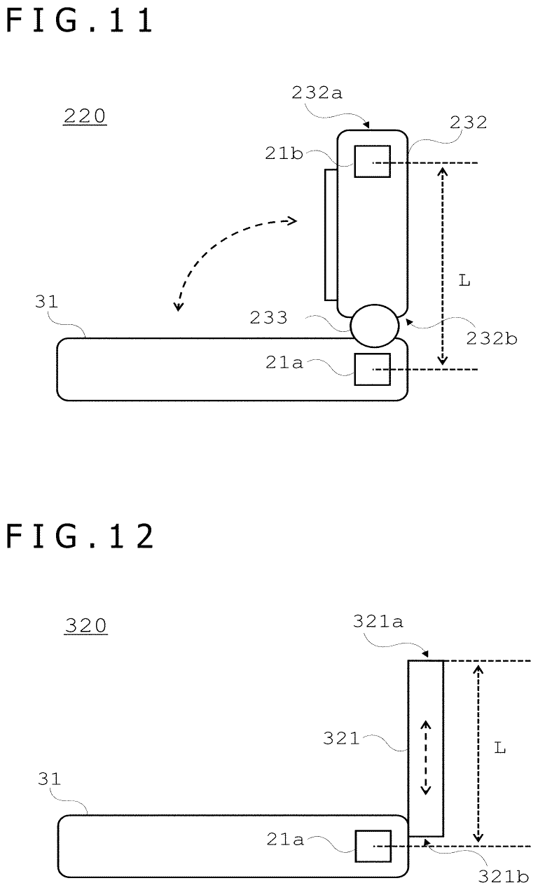

FIG. 11 is a diagram schematically depicting a structure of a housing of a controller 220 related to a second embodiment of the present disclosure. The housing of the controller 220 includes a main body 31 gripped by the user, a movable part 232 attached pivotably to the main body 31, and a pivot shaft 233.

The movable part 232 has a tip end part 232a and a base end part 232b. The base end part 232b is attached to the main body 31 via the pivot shaft 233. The movable part 232 can transition from a first state in which the tip end part 232a falls on the side of the main body 31 to a second state in which the tip end part 232a rises from the main body 31. The second antenna 21b is fixedly placed inside the movable part 232 near the tip end thereof.

While the controller 220 is stored, the movable part 232 is in the first state. Only when the controller 220 is in use, i.e., only when the controller 220 communicates wirelessly with the drone 10, is the movable part 232 in the second state. When the movable part 232 is in the second state, the first antenna 21a and the second antenna 21b are the predetermined length L apart in the vertical direction. Such characteristics, as in the case of the first embodiment above, allow the controller 220 of the second embodiment to improve the propagation loss caused by the interference between the direct wave and the reflected wave of the radio signals being received. Also, the storability of the controller 220 is enhanced.

### Third Embodiment

FIG. 12 is a diagram schematically depicting a structure of a housing of a controller 320 related to a third embodiment of the present disclosure. The housing of the controller 320 includes only the main body 31 gripped by the user. The first antenna 21a is fixedly placed inside the main body 31. A second antenna 321 can extend and retract in the vertical direction. A base end part 321b of the second antenna 321 is fixed to the main body 31.

During storage of the controller 320, the second antenna 321 is retracted. Only when the controller 320 is in use, i.e., only when the controller 320 communicates wirelessly with the drone 10, is the second antenna 321 extended. When the second antenna 321 is in the extended state, the first antenna 21a and a tip end part 321a of the second antenna 321 are the predetermined length L apart in the vertical direction. Such characteristics allow the controller 320 of the third embodiment to improve the propagation loss caused by the interference between the direct wave and the reflected wave of the radio signals being received. Also, the storability of the controller 320 is enhanced.

Although some embodiments of the present disclosure have been described above, these embodiments are presented merely as examples and are not intended to limit the scope of the present disclosure. The above embodiments can be implemented in diverse variations including deletion, replacement, change, and combining of some of their constituent elements as long as such variations fall within the scope of the present disclosure. It is hence to be understood that the embodiments and their variations are within the spirit and scope of the present disclosure and also fall within the scope of the appended claims or the equivalents thereof.

The processes of the present disclosure are also not limited to any specific standard. The settings presented as examples may be modified as appropriate. The procedures according to an embodiment of the present disclosure may be construed as constituting a method that has a series of such procedures. Alternatively, the procedures according to an embodiment of the present disclosure may be construed as forming a program for causing a computer to execute a series of such procedures, or as constituting a recording medium that stores such a program. In such a case, the processes according to an embodiment of the present disclosure are executed by a processor such as the CPU of a computer. Further, the type of the recording medium is not limited to anything specific since it has little effect on how the present disclosure may be implemented.

Further, the constituent elements depicted in FIGS. 2 and 3 may be implemented by software or by hardware. For example, each of the constituent elements may be a software module implemented by software such as a microprogram. Each constituent element may then be implemented by a processor executing the corresponding software module. Alternatively, each constituent element may be implemented by circuit blocks on a semiconductor chip (die), such as integrated circuits including an ASIC (Application Specific Integrated Circuit) or an FPGA (Field Programmable Gate Array), for example. Further, the number of constituent elements may or may not coincide with the number of hardware components that implement the constituent elements. For example, one processor or circuit may implement multiple constituent elements. Conversely, one constituent element may be implemented by multiple processors or circuits.

Further, the type of the processor described in the present disclosure is not limited to anything specific. For example, the processor may be a CPU (Central Processing Unit), an MPU (Micro Processing Unit), or a GPU (Graphics Processing Unit).

Furthermore, the advantageous effects stated in the present description are merely examples and not limitative of the present disclosure that may provide other advantages as well.

Note that the present disclosure can also adopt the following configurations.

### [Item 1]

A wireless communication apparatus including:
multiple antennas;
multiple reception sections each connected to a corresponding one of the multiple antennas and configured to receive a radio signal through the corresponding one of the multiple antennas; and
an adjustment section configured to generate a received signal by performing a reception process in reference to the radio signal received in plural number by the multiple reception sections,
in which a first antenna and a second antenna included in the multiple antennas are a predetermined length apart in a vertical direction.

### [Item 2]

The wireless communication apparatus according to item 1, in which the predetermined length is set to be 0.5 to 0.9 times a wavelength of the radio signal.

### [Item 3]

The wireless communication apparatus according to item 2, in which the predetermined length is set to be 60 to 113 mm when a frequency of the radio signal is 2.4 GHZ and 25 to 54 mm when the frequency of the radio signal is 5 GHZ.

### [Item 4]

The wireless communication apparatus according to any one of items 1 through 3, in which the first antenna and the second antenna each have a reference position determined thereon,
the reference position is any one of a feeding point, a tip end part, a base end part, or an attaching part of the first antenna and the second antenna, and
the reference position of the first antenna and the reference position of the second antenna are the predetermined length apart in the vertical direction.

### [Item 5]

The wireless communication apparatus according to any one of items 1 through 4, in which the first antenna and the second antenna are any one of a dipole antenna, a microstrip antenna, or a sector antenna each.

### [Item 6]

The wireless communication apparatus according to any one of items 1 through 5, further including:
a main body; and
an extension part configured to extend from the main body in the vertical direction,
in which the first antenna is fixed to the main body, and the second antenna is fixed to the extension part.

### [Item 7]

The wireless communication apparatus according to any one of items 1 through 5, further including:
a main body; and
a movable part that has a tip end part and a base end part, the base end part being pivotably attached to the main body,
in which the movable part is able to transition from a first state in which the tip end part falls on the side of the main body to a second state in which the tip end part rises from the main body,
the first antenna is fixed to the main body, and the second antenna is fixed to the movable part, and,
when the movable part is in the second state, the first antenna and the second antenna are the predetermined length apart in the vertical direction.

### [Item 8]

The wireless communication apparatus according to any one of items 1 through 5, further including:
a main body,
in which the second antenna has a tip end part and a base end part and is able to extend and retract in the vertical direction,
the first antenna is fixed to the main body, and the base end part of the second antenna is fixed to the main body, and,
when the second antenna is in an extended state, the first antenna and the tip end part of the second antenna are the predetermined length apart in the vertical direction.

### [Item 9]

The wireless communication apparatus according to any one of items 1 through 8, in which the adjustment section implements either selective diversity or maximum ratio combining diversity.

### [Item 10]

The wireless communication apparatus according to any one of items 1 through 9, in which the wireless communication apparatus is a controller of an unmanned aircraft.

### [Item 11]

The wireless communication apparatus according to any one of items 1 through 9, in which the wireless communication apparatus is an unmanned aircraft.

### [Item 12]

A wireless communication method including:
arranging multiple antennas in such a manner that a first antenna and a second antenna included in the multiple antennas are a predetermined length apart in a vertical direction;
receiving a radio signal through the multiple antennas; and
generating a received signal by performing a reception process in reference to the multiple radio signals.

### REFERENCE SIGNS LIST

10: Drone (wireless communication apparatus)
11: Antenna
12: Reception section
13: Demodulation section
14: Flight control section
15: Camera
16: Modulation section
17: Transmission section
20: Controller (wireless communication apparatus)
21a: First antenna
21b: Second antenna
22a: First reception section
22b: Second reception section
23: Adjustment section
24: Demodulation section
25: Display section
26: Operation section
27: Generation section
28: Modulation section
29: Transmission section
31: Main body
32: Extension part
40: Dipole antenna
41: Cable
42: Feeding point
43: Lead wire
44: Lead wire
45: Tip end part
46: Base end part
47: Attaching part
50: Microstrip antenna
51: Feeding point
52: Tip end part
53: Base end part
54: Attaching part
100: Unmanned aircraft system
220: Controller (wireless communication apparatus)
232: Movable part
232a: Tip end part of movable part
232b: Base end part of movable part
233: Pivot shaft
320: Controller (wireless communication apparatus)
321: Second antenna
321a: Tip end part of second antenna
321b: Base end part of second antenna
D: Communication distance
f: Frequency of radio signal
Hr: Height of first antenna from ground
Hr+L: Height of second antenna from ground
Ht: Height of drone antenna from ground
L: Predetermined length
λ: Wavelength of radio signal

1. A wireless communication apparatus comprising:
multiple antennas;
multiple reception sections each connected to a corresponding one of the multiple antennas and configured to receive a radio signal through the corresponding one of the multiple antennas; and
an adjustment section configured to generate a received signal by performing a reception process in reference to the radio signal received in plural number by the multiple reception sections,
wherein a first antenna and a second antenna included in the multiple antennas are a predetermined length apart in a vertical direction.

2. The wireless communication apparatus according to claim 1, wherein the predetermined length is set to be 0.5 to 0.9 times a wavelength of the radio signal.

3. The wireless communication apparatus according to claim 2, wherein the predetermined length is set to be 60 to 113 mm when a frequency of the radio signal is 2.4 GHZ and 25 to 54 mm when the frequency of the radio signal is 5 GHZ.

4. The wireless communication apparatus according to claim 1, wherein the first antenna and the second antenna each have a reference position determined thereon,
the reference position is any one of a feeding point, a tip end part, a base end part, or an attaching part of the first antenna and the second antenna, and
the reference position of the first antenna and the reference position of the second antenna are the predetermined length apart in the vertical direction.

5. The wireless communication apparatus according to claim 1, wherein the first antenna and the second antenna are any one of a dipole antenna, a microstrip antenna, or a sector antenna each.

6. The wireless communication apparatus according to claim 1, further comprising:
a main body; and
an extension part configured to extend from the main body in the vertical direction,
wherein the first antenna is fixed to the main body, and the second antenna is fixed to the extension part.

7. The wireless communication apparatus according to claim 1, further comprising:
a main body; and
a movable part that has a tip end part and a base end part, the base end part being pivotably attached to the main body,
wherein the movable part is able to transition from a first state in which the tip end part falls on the side of the main body to a second state in which the tip end part rises from the main body,
the first antenna is fixed to the main body, and the second antenna is fixed to the movable part, and,
when the movable part is in the second state, the first antenna and the second antenna are the predetermined length apart in the vertical direction.

8. The wireless communication apparatus according to claim 1, further comprising:
a main body,
wherein the second antenna has a tip end part and a base end part and is able to extend and retract in the vertical direction,
the first antenna is fixed to the main body, and the base end part of the second antenna is fixed to the main body, and,
when the second antenna is in an extended state, the first antenna and the tip end part of the second antenna are the predetermined length apart in the vertical direction.

9. The wireless communication apparatus according to claim 1, wherein the adjustment section implements either selective diversity or maximum ratio combining diversity.

10. The wireless communication apparatus according to claim 1, wherein the wireless communication apparatus is a controller of an unmanned aircraft.

11. The wireless communication apparatus according to claim 1, wherein the wireless communication apparatus is an unmanned aircraft.

12. A wireless communication method comprising:
arranging multiple antennas in such a manner that a first antenna and a second antenna included in the multiple antennas are a predetermined length apart in a vertical direction;
receiving a radio signal through the multiple antennas; and
generating a received signal by performing a reception process in reference to the multiple radio signals.
